(19) United States
(12) Patent Application Publication
(10) Pub. No.: US 2017/0107466 A1
(43) Pub. Date: Apr. 20, 2017

(54) DISTILLED PLUM LIQUOR

(71) Applicant: SUNTORY HOLDINGS LIMITED, Osaka-shi, Osaka (JP)

(72) Inventor: Akiyuki YOKOYAMA, Osaka (JP)

(21) Appl. No.: 15/127,075

(22) PCT Filed: Mar. 25, 2015
(86) PCT No.: PCT/JP2015/059085

§ 371 Date: Sep. 19, 2016

(30) Foreign Application Priority Data
Mar. 28, 2014 (JP) 2014-070524

(51) Int. Cl. C12G 3/04; C12G 3/12

(52) U.S. Cl. CPC C12G 3/04; C12G 3/12

(57) ABSTRACT

An object of the present invention is to provide a technique for masking the bitterness and astringency of an unrefined distilled plum liquor.

By incorporating a specified amount of at least one selected from isobutyric acid, acetic acid, and benzaldehyde in an unrefined distilled plum liquor, there can be provided a distilled plum liquor in which the bitterness and astringency derived from the unrefined distilled plum liquor is masked.

### TECHNICAL FIELD

The present invention relates to distilled plum liquors. More particularly, this invention relates to a technique for masking the bitterness and astringency derived from an unrefined distilled plum liquor by increasing the amount(s) of at least one component contained in the unrefined distilled plum liquor.

### BACKGROUND ART

There were various known types of fruit liquors (also called “liqueurs”) made by infusing alcohols with fruits; for example, plum liquor, Chinese quince liquor, and lemon liquor (limoncello). Since long ago, fruit liquors have been made not only in households but also on an industrial scale. Liquors obtained by distilling a plum liquor are called distilled plum liquors, plum spirits, plum liquor distillates, or the like (hereinafter referred to as “distilled plum liquors”), and are receiving attraction in that they have a fruity fragrance derived from a plum liquor but do not contain sugars abundant in a plum liquor, thereby having health advantages. For example, there are known methods for producing distilled plum liquors, such as a method characterized by subjecting a plum liquor diluted with water to distillation under reduced pressure (Patent Literature 1: JP 2006-109799).

In this connection, plum liquors contain many components derived from plum fruits and seeds; for example, benzaldehyde was known to be an aroma component associated with the aroma typical of plum liquors (Non-Patent Literature 1: Arikawa T., et. al., “Aroma Substances in Umeshu (Japanese Apricot Liqueur) and Their Changes during Storage,” Journal of Home Economics of Japan, 1997, vol. 48, no. 4, p. 295-301).

### CITATION LIST

### Patent Literature

Patent Literature 1: Japanese Patent Application Publication No. JP 2006-109799

### Non-Patent Literature

Non-Patent Literature 1: Arikawa T., et. al., “Aroma Substances in Umeshu (Japanese Apricot Liqueur) and Their Changes during Storage,” Journal of Home Economics of Japan, 1997, vol. 48, no. 4, p. 295-301

### SUMMARY OF INVENTION

### Technical Problem

As described above, plum liquors contain many kinds of components, but it was revealed by the studies of the present inventors that unrefined liquors obtained by distilling a plum liquor contain some components giving unpleasant tastes such as bitterness and astringency. It was also found that the discomfort in drinking which is peculiar to those components causes unrefined distilled plum liquors themselves to be uncomfortable to drink. Therefore, there is a demand to develop distilled plum liquors which are improved in taste by reducing those unpleasant tastes.

Thus, an object of the present invention is to provide a technique for masking the bitterness and astringency of an unrefined distilled plum liquor.

### Solution to Problem

The present inventors have made intensive studies with a view to achieving the above-mentioned object, and as a result found that, when a specified amount of at least one selected from isobutyric acid, acetic acid and benzaldehyde is incorporated in a distilled plum liquor, the peculiar discomfort in drinking which is derived from bitterness/astringency components can be eliminated, thereby obtaining a distilled plum liquor with an extremely pleasant taste. Thus, the inventors have completed the present invention.

The present invention includes, but is not limited to, the following aspects of the invention.

(1) A distilled plum liquor, comprising at least one selected from the following components, based on the total amount of the distilled plum liquor:

(a) 0.6 to 75 ppm of isobutyric acid,

(b) 12.6 to 85 ppm of acetic acid, and

(c) 12.4 to 77 ppm of benzaldehyde.

(2) The distilled plum liquor as set forth in (1), comprising at least two selected from the components (a) to (c).
(3) The distilled plum liquor as set forth in (1) or (2), further comprising at least one selected from the following components, based on the total amount of the distilled plum liquor:

(d) 0.8 to 15 ppm of 2-methylbutyric acid,

(e) 4.9 to 50 ppm of caproic acid,

(f) 1.1 to 4.5 ppm of ethyl benzoate, and

(g) 1.8 to 9 ppm of benzyl alcohol.

(4) The distilled plum liquor as set forth in any one of (1) to (3), further comprising at least one selected from the following components, based on the total amount of the distilled plum liquor:

(h) 1 to 50 ppm of diethyl malate,

(i) 0.1 to 2 ppm of diethyl succinate, and

(j) 0.1 to 5 ppm of triethyl citrate.

(5) A distilled plum liquor, comprising:

at least one selected from (a) isobutyric acid, (b) acetic acid, and (c) benzaldehyde; and

at least one selected from (h) diethyl malate, (i) diethyl succinate, and (j) triethyl citrate;

wherein the relative ratios of the components satisfy the following relations:

[weight of (a)/weight of (h)]=0.04 to 4.8,

[weight of (b)/weight of (h)]=0.79 to 5.4,

[weight of (c)/weight of (h)]=0.78 to 4.82,

[weight of (a)/weight of (i)]=1.0 to 125,

[weight of (b)/weight of (i)]=21 to 142,

[weight of (c)/weight of (i)]=20.6 to 129,

[weight of (a)/weight of (j)]=0.35 to 47,

[weight of (b)/weight of (j)]=7.75 to 55, and

[weight of (c)/weight of (j)]=7.75 to 48.

(6) The distilled plum liquor as set forth in (5), comprising at least two selected from the components (a) to (c).
(7) The distilled plum liquor as set forth in (5) or (6), further comprising at least one selected from (d) 2-methylbutyric acid, (e) caproic acid, (f) ethyl benzoate, and (g) benzyl alcohol,

wherein the relative ratios of the components satisfy the following relations:

[weight of (d)/weight of (h)]=0.05 to 0.94,

[weight of (e)/weight of (h)]=0.31 to 3.13,

[weight of (f)/weight of (h)]=0.07 to 0.28,

[weight of (g)/weight of (h)]=0.12 to 0.56,

[weight of (d)/weight of (i)]=1.3 to 25,

[weight of (e)/weight of (i)]=8.1 to 84,

[weight of (f)/weight of (i)]=1.8 to 7.5,

[weight of (g)/weight of (i)]=1.8 to 15,

[weight of (d)/weight of (j)]=0.5 to 10,

[weight of (e)/weight of (j)]=3.05 to 31,

[weight of (0/weight of (j)]=0.7 to 3, and

[weight of (g)/weight of (j)]=1.15 to 6.

(8) The distilled plum liquor as set forth in any one of (5) to (7), comprising at least one selected from the following components, based on the total amount of the distilled plum liquor:

(a) 0.6 to 75 ppm of isobutyric acid,

(b) 12.6 to 85 ppm of acetic acid, and

(c) 12.4 to 77 ppm of benzaldehyde.

(9) A method for producing a distilled plum liquor, the method comprising the step of adding, to an unrefined distilled plum liquor, at least one selected from the following components in the following relative additional amount(s):

(a) a relative additional amount of 0.1 to 75 ppm of isobutyric acid,

(b) a relative additional amount of 0.3 to 73 ppm of acetic acid, and

(c) a relative additional amount of 0.3 to 65 ppm of benzaldehyde.

(10) The method as set forth in (9), wherein at the addition step, at least two selected from the components (a) to (c) are added.
(11) The method as set forth in (9) or (10), wherein at the addition step, at least one selected from the following components is further added in the following relative additional amount(s), based on the total amount of the distilled plum liquor:

(d) a relative additional amount of 0.3 to 15 ppm of 2-methylbutyric acid,

(e) a relative additional amount of 0.3 to 46 ppm of caproic acid,

(f) a relative additional amount of 0.1 to 3.5 ppm of ethyl benzoate, and

(g) a relative additional amount of 0.1 to 7.5 ppm of benzyl alcohol.

(12) The method as set forth in any one of (9) to (11), wherein at the addition step, at least one selected from the following components is further incorporated, based on the total amount of the distilled plum liquor:

(h) 1 to 50 ppm of diethyl malate,

(i) 0.1 to 2 ppm of diethyl succinate, and

(j) 0.1 to 5 ppm of triethyl citrate.

### Advantageous Effects of Invention

According to the present invention, the bitterness and astringency contained in an unrefined distilled plum liquor can be masked to thereby provide a comfortable-to-drink distilled plum liquor.

### DESCRIPTION OF EMBODIMENTS

Hereunder, embodiments of the present invention will be illustrated with examples. Unless otherwise specified, the descriptions given below about a distilled plum liquor, which is one aspect of this invention, apply in the same way to a distilled plum liquor as referred to in relation to a distilled plum liquor production method, which is another aspect of this invention.

<Distilled Plum Liquor>

For the purpose of the present invention, the “distilled plum liquor” refers to a beverage comprising, as a main ingredient, an unrefined distilled plum liquor obtained by distilling a plum liquor.

Unless otherwise specified, the term “relative amount (ppm)” as used herein refers to the relative amount of a certain component contained based on the total amount of a distilled plum liquor.

Unless otherwise specified, the term “relative additional amount (ppm)” as used herein refers to the amount of a certain component increased by adding the certain component to a distilled plum liquor, and is calculated by subtracting the amount of the certain component contained before its addition, based on the total amount of a distilled plum liquor, from that relative amount of the component after its addition.

Plum Liquor

The plum liquor used to produce an unrefined distilled plum liquor in the present invention is not particularly limited as long as it is a plum liquor produced by infusing an alcoholic beverage with a plum. Examples of such plum liquors include plum liquors commonly sold and made available as commercial products, and a plum liquor obtained by mixing an infused liquor of a pulverized frozen green plum with an infused liquor of a pulverized frozen ripened plum as described in Japanese Patent No. JP 4585458. The type of a plum used as an ingredient for producing a plum liquor is not particularly limited, and a green or fully ripened plum can be used.

Unrefined Distilled Plum Liquor

For the purpose of the present invention, the “unrefined distilled plum liquor” refers to a liquor obtained by distilling a plum liquor, and is used as a base ingredient for producing the distilled plum liquor of the present invention. The distillation of a plum liquor can be performed by a known method such as distillation under reduced pressure or steam distillation under reduced pressure. The method for performing distillation under reduced pressure is not particularly limited, and this type of distillation can be performed using a method known to those skilled in the art under the following conditions: a pressure of 20 to 200 mmHg, and a temperature of 25 to 65° C. By performing this type of distillation, there can be obtained a distilled plum liquor which is scarcely colored and has a liquid color very close to colorless and transparent.

The amount of an unrefined distilled plum liquor contained in a distilled plum liquor is not particularly limited; for example, the unrefined distilled plum liquor is present in an amount of 0.01 to 100% by weight, preferably 1 to 50% by weight, more preferably 1 to 33% by weight, based on the total amount of a distilled plum liquor.

Components (a) to (g)

In the present invention, by incorporating a specified amount of at least one selected from components (a) to (c) as described below, the unpleasant bitterness and astringency derived from an unrefined distilled plum liquor can be reduced, thereby achieving an improvement in taste. Also, by incorporating a combination of at least two selected from components (a) to (c) in specified amounts, a distilled plum liquor having a more pleasant taste can be obtained. These components may be those contained in an unrefined distilled plum liquor, or may be added to a distilled plum liquor. In particular, by adding any or all of these components to a distilled plum liquor in the form of a flavorant(s) containing any of them alone or a mixture of them, there can be obtained a distilled plum liquor which is scarcely colored and has a liquid color very close to colorless and transparent.

(a) Isobutyric acid (also designated as 2-methylpropanoic acid, dimethylacetic acid, or the like): The distilled plum liquor of this invention comprises isobutyric acid in a relative amount of preferably 0.6 to 75 ppm, more preferably 0.8 to 45 ppm, and still more preferably 1.2 to 25 ppm, based on the total amount of the distilled plum liquor. The relative additional amount of isobutyric acid to be added to an unrefined distilled plum liquor is in the range of preferably 0.1 to 75 ppm, more preferably 0.3 to 45 ppm, and still more preferably 0.7 to 25 ppm, based on the total amount of the distilled plum liquor.
(b) Acetic acid: The inventive distilled plum liquor comprises acetic acid in a relative amount of preferably 12.6 to 85 ppm, more preferably 14 to 67 ppm, and still more preferably 16 to 47 ppm, based on the total amount of the distilled plum liquor. The relative additional amount of acetic acid to be added to an unrefined distilled plum liquor is in the range of preferably 0.3 to 73 ppm, more preferably 2.0 to 55 ppm, and still more preferably 4 to 35 ppm, based on the total amount of the distilled plum liquor.
(c) Benzaldehyde: The inventive distilled plum liquor comprises benzaldehyde in a relative amount of preferably 12.4 to 77 ppm, more preferably 16 to 67 ppm, and still more preferably 20 to 57 ppm, based on the total amount of the distilled plum liquor. The relative additional amount of benzaldehyde to be added to an unrefined distilled plum liquor is in the range of preferably 0.3 to 65 ppm, more preferably 4 to 55 ppm, and still more preferably 8 to 45 ppm, based on the total amount of the distilled plum liquor.

In the present invention, by incorporating not only at least one selected from the components (a) to (c) but also a specified amount of at least one selected from components (d) to (g) as described below, a distilled plum liquor having a more pleasant taste can be obtained.

(d) 2-Methylbutyric acid (also designated as 2-ethylpropionic acid, 2-methylbutanoic acid, or the like): The distilled plum liquor of this invention comprises 2-methylbutyric acid in a relative amount of preferably 0.8 to 15 ppm based on the total amount of the distilled plum liquor. The relative additional amount of 2-methylbutyric acid to be added to an unrefined distilled plum liquor is in the range of preferably 0.3 to 15 ppm based on the total amount of the distilled plum liquor.
(e) Caproic acid (also designated as hexanoic acid, or the like): The inventive distilled plum liquor comprises caproic acid in a relative amount of preferably 4.9 to 50 ppm, more preferably 6.5 to 20 ppm, based on the total amount of the distilled plum liquor. The relative additional amount of caproic acid to be added to an unrefined distilled plum liquor is in the range of preferably 0.3 to 46 ppm, more preferably 2 to 16 ppm, based on the total amount of the distilled plum liquor.
(f) Ethyl benzoate: The inventive distilled plum liquor comprises ethyl benzoate in a relative amount of preferably 1.1 to 4.5 ppm based on the total amount of the distilled plum liquor. The relative additional amount of ethyl benzoate to be added to an unrefined distilled plum liquor is in the range of preferably 0.1 to 3.5 ppm based on the total amount of the distilled plum liquor.
(g) Benzyl alcohol: The inventive distilled plum liquor comprises benzyl alcohol in a relative amount of preferably 1.8 to 9 ppm based on the total amount of the distilled plum liquor. The relative additional amount of benzyl alcohol to be added to an unrefined distilled plum liquor is in the range of preferably 0.1 to 7.5 ppm based on the total amount of the distilled plum liquor.

In the process of adding the components, a purified product(s) or an extract(s) may be used, or a flavorant(s) containing any one of these components alone or at least two of them may be used.

Bitterness/Astringency Components (h) to (j)

(h) Diethyl malate, (i) diethyl succinate, and (j) triethyl citrate: It was revealed by the studies of the present inventors that diethyl malate, diethyl succinate, and triethyl citrate contained in an unrefined distilled plum liquor are causative agents for the discomfort in drinking (bitterness and astringency) which is peculiar to a distilled plum liquor. It was also found that the discomfort in drinking of a distilled plum liquor becomes more intense with an increase in the relative amounts of diethyl malate, diethyl succinate, and triethyl citrate.

Thus, the distilled plum liquor of the present invention may further contain, for example, at least one or at least two selected from the components (h) to (j), or three of them.

The relative amounts of diethyl malate, diethyl succinate, and triethyl citrate in the distilled plum liquor of the present invention vary with the type of a plum liquor used as an ingredient and the distillation conditions. For example, the inventive distilled plum liquor contains diethyl malate in a relative amount of 1 to 50 ppm, 3 to 30 ppm, or 4 to 25 ppm, diethyl succinate in a relative amount of 0.1 to 2 ppm, or 0.5 to 1 ppm, and triethyl citrate in a relative amount of 0.1 to 5 ppm, or 0.3 to 3.5 ppm, based on the total amount of the distilled plum liquor.

Relative Ratios of Components

The following gives descriptions about the relative ratios of the weight of each of the aforementioned components (a) to (g) contained in the inventive distilled plum liquor to the weight of each of (h) diethyl malate, (i) diethyl succinate, and (j) triethyl citrate, as well as about the relative ratios of the relative additional amount of each of the aforementioned components (a) to (g) to be added to an unrefined distilled plum liquor to the weight of each of components (h) to (j).

In the case of (h) diethyl malate, the ratio [weight of (a)/weight of (h)] is in the range of 0.04 to 4.8, preferably 0.05 to 2.8, more preferably 0.07 to 1.6; the ratio [weight of (b)/weight of (h)] is in the range of 0.79 to 5.4, preferably 0.87 to 4.2, more preferably 1 to 3; the ratio [weight of (c)/weight of (h)] is in the range of 0.78 to 4.82, preferably 1 to 4.2, more preferably 1.25 to 3.6; the ratio [weight of (d)/weight of (h)] is in the range of 0.05 to 0.94; the ratio [weight of (e)/weight of (h)] is in the range of 0.31 to 3.13, preferably 0.42 to 1.25; the ratio [weight of (f)/weight of (h)] is in the range of 0.07 to 0.28; and the ratio [weight of (g)/weight of (h)] is in the range of 0.12 to 0.56. Further, the ratio [relative additional amount of (a)/weight of (h)] is in the range of 0.01 to 4.69, preferably 0.02 to 2.81, more preferably 0.04 to 1.56; the ratio [relative additional amount of (b)/weight of (h)] is in the range of 0.02 to 4.69, preferably 0.11 to 3.44, more preferably 0.24 to 2.19; the ratio [relative additional amount of (c)/weight of (h)] is in the range of 0.02 to 4.06, preferably 0.24 to 3.44, more preferably 0.47 to 2.81; the ratio [relative additional amount of (d)/weight of (h)] is in the range of 0.02 to 0.94; the ratio [relative additional amount of (e)/weight of (h)] is in the range of 0.02 to 2.81, preferably 0.12 to 0.94; the ratio [relative additional amount of (f)/weight of (h)] is in the range of 0.01 to 0.24; and the ratio [relative additional amount of (g)/weight of (h)] is in the range of 0.01 to 0.47.

In the case of (i) diethyl succinate, the ratio [weight of (a)/weight of (i)] is in the range of 1.0 to 125, preferably 1.35 to 75, more preferably 2 to 42; the ratio [weight of (b)/weight of (i)] is in the range of 21 to 142, preferably 23 to 111, more preferably 26 to 79; the ratio [weight of (c)/weight of (i)] is in the range of 20.6 to 129, preferably 26 to 112, more preferably 33 to 95; the ratio [weight of (d)/weight of (i)] is in the range of 1.3 to 25; the ratio [weight of (e)/weight of (i)] is in the range of 8.1 to 84, preferably 10.8 to 34; the ratio [weight of (f)/weight of (i)] is in the range of 1.8 to 7.5; and the ratio [weight of (g)/weight of (i)] is in the range of 1.8 to 15. Further, the ratio [relative additional amount of (a)/weight of (i)] is in the range of 0.01 to 4.69, preferably 0.02 to 2.81, more preferably 0.04 to 1.56; the ratio [relative additional amount of (b)/weight of (i)] is in the range of 0.02 to 4.69, preferably 0.11 to 3.44, more preferably 0.24 to 2.19; the ratio [relative additional amount of (c)/weight of (i)] is in the range of 0.02 to 4.06, preferably 0.24 to 3.44, more preferably 0.47 to 2.81; the ratio [relative additional amount of (d)/weight of (i)] is in the range of 0.02 to 0.94; the ratio [relative additional amount of (e)/weight of (i)] is in the range of 0.02 to 2.81, preferably 0.12 to 0.94; the ratio [relative additional amount of (f)/weight of (i)] is in the range of 0.01 to 0.24; and the ratio [relative additional amount of (g)/weight of (i)] is in the range of 0.01 to 0.47.

In the case of (j) triethyl citrate, the ratio [weight of (a)/weight of (j)] is in the range of 0.35 to 47, preferably 0.5 to 28, more preferably 0.75 to 16; the ratio [weight of (b)/weight of (j)] is in the range of 7.75 to 55, preferably 9 to 42, more preferably 10 to 30; the ratio [weight of (c)/weight of (j)] is in the range of 7.75 to 48, preferably 10 to 42, more preferably 12 to 36; the ratio [weight of (d)/weight of (j)] is in the range of 0.5 to 10; the ratio [weight of (e)/weight of (j)] is in the range of 3.05 to 31, preferably 3.9 to 12; the ratio [weight of (f)/weight of (j)] is in the range of 0.7 to 3; and the ratio [weight of (g)/weight of (j)] is in the range of 1.15 to 6. Further, the ratio [relative additional amount of (a)/weight of (j)] is in the range of 0.01 to 4.69, preferably 0.02 to 2.81, more preferably 0.04 to 1.56; the ratio [relative additional amount of (b)/weight of (j)] is in the range of 0.02 to 4.69, preferably 0.11 to 3.44, more preferably 0.24 to 2.19; the ratio [relative additional amount of (c)/weight of (j)] is in the range of 0.02 to 4.06, preferably 0.24 to 3.44, more preferably 0.47 to 2.81; the ratio [relative additional amount of (d)/weight of (j)] is in the range of 0.02 to 0.94; the ratio [relative additional amount of (e)/weight of (j)] is in the range of 0.02 to 2.81, preferably 0.12 to 0.94; the ratio [relative additional amount of (f)/weight of (j)] is in the range of 0.01 to 0.24; and the ratio [relative additional amount of (g)/weight of (j)] is in the range of 0.01 to 0.47.

Other Additives

The distilled plum liquor of the present invention may contain, in addition to the components described hereinabove, water and/or other known components to be included in beverages, such as sugars, sweeteners, acidulants, flavorants, and pigments, to the extent that the effects of the present invention are not impaired.

Water can be of any type suitable for drinking purpose; for example, pure water, hard water, soft water, ion exchanged water, ionized alkaline water, or degassed water obtained by degassing any of the aforementioned types of water, or any other type of water can be used as appropriate. The amount of water is not particularly limited, and can be determined as appropriate depending on the alcohol contents of an unrefined distilled plum liquor and a finished product; for example, the amount of water is in the range of 0 to 99% by weight, preferably 0 to 60% by weight, more preferably 0 to 30% by weight, based on the total amount of a distilled plum liquor.

The alcohol content of the distilled plum liquor of the present invention is in the range of 1 to 70%, preferably 10 to 45%, more preferably 15 to 35%.

<Method for Producing a Distilled Plum Liquor>

Another aspect of the present invention is a method for producing a distilled plum liquor. The production method of this aspect of the invention is characterized by comprising the step of adding at least one selected from (a) isobutyric acid, (b) acetic acid, and (c) benzaldehyde to an unrefined distilled plum liquor. By taking this step, the bitterness and astringency derived from an unrefined distilled plum liquor can be masked. The bitterness and astringency derived from an unrefined distilled plum liquor can be further masked by adding at least two selected from the aforementioned components (a) to (c). Further, at least one selected from (d) 2-methylbutyric acid, (e) caproic acid, (f) ethyl benzoate, and (g) benzyl alcohol may also be added.

The production method of this aspect of the invention may further comprise the steps of, for example: obtaining a plum liquor; distilling the plum liquor to obtain an unrefined distilled plum liquor; and diluting the unrefined distilled plum liquor with water. It does not matter which of the dilution step and the addition step precedes the other.

In this aspect of the invention, as regards the relative amounts and additional relative amounts of components (a) to (g) in the distilled plum liquor, the relative ratios of the weight of each of components (a) to (g) to the weight of each of bitterness/astringency components (h) to (j), and the relative ratios of the relative additional amount of each of components (a) to (g) to the weight of each of bitterness/astringency components (h) to (j), descriptions have been given above in relation to the inventive distilled plum liquor.

### EXAMPLES

Hereunder, the present invention will be described more specifically by way of working examples. However, this invention is not limited to these examples.

The experimental systems used in the working examples are enumerated below.

Analyzer:

Gas chromatography system (Agilent GC-MSD)

GC oven temperature condition:

40° C. (for 5 min), increased at 6° C./min to 240° C.

MS conditions:

Quadrupole setting: 150, ion source setting: 230 Area value calculation conditions:
Total ion mode, mass (LOW): 35, and mass (HIGH): 550

Column:

DB-WAXETR, 60 m×320 μm ID×0.25 μm film thickness

Sample pretreatment condition:

80 μL of a sample and 20 mL of an internal standard material (aqueous alcohol solution of 20 ppm of decanoic acid methyl ester) were mixed in a 20 mL screw cap vial.

Dynamic headspace conditions:

System: GERSTEL MPS

Adsorbent: TENAX

Sample gasification temperature: 80° C.

Feed amount of sample gasification gas: 3000 mL

Feed rate of sample gasification gas: 100 mL/min

Type of sample gasification gas: Nitrogen

Peak retention time:

Identification of components and their concentrations was performed by MS analysis.

### Example 1: Analysis of Bitterness/Astringency Masking Effect

### <Production of an Unrefined Distilled Plum Liquor>

Half a kilogram of sugar and 1.2 L of a 40% (v/v) alcohol solution (neutral spirits) were mixed per kg of raw green plum, and infusion was continued for 6 months, whereby a plum liquor with an alcohol content of 20% (v/v) was produced. 3 L of the plum liquor with an alcohol content of 20% (v/v) was charged into a distiller, and reduced-pressure distillation was started under the distiller's internal air pressure of 75 mmHg. When the volume of the distillate reached 2 L, the distillation was stopped. Thus, there was prepared an unrefined distilled plum liquor.

### <Analysis of Bitterness/Astringency Components>

In order to verify the bitterness/stringency masking effect of the inventive distilled plum liquor, an analysis was made of the relationship between the particular components derived from the unrefined distilled plum liquor and the degree of bitterness and astringency.

The unrefined distilled plum liquor (1 L) and water (2 L) were mixed at a ratio of [unrefined liquor:water]=1:2 to prepare distilled plum liquor A (3 L) with an alcohol content of 9%, which was named sample No. 1. The components and their relative amounts of distilled plum liquor A (sample No. 1) were determined according to the component analysis method described above, and are shown in Table 1. Sample Nos. 2 to 7 were each prepared by adding diethyl malate, diethyl succinate, or triethyl citrate to distilled plum liquor A (30 mL) in a relative additional amount of 10 ppm or 20 ppm. Sample Nos. 1 to 7 were subjected to sensory evaluation to determine the degree of bitterness and astringency. The sensory evaluation was conducted by expert panelists according to the following criteria.

4 points: Uncomfortable to drink (bitterness and astringency linger in the mouth)

3 points: Fairly uncomfortable to drink

2 points: Particularly uncomfortable to drink

1 point: Extremely uncomfortable to drink

TABLE 1
Chemical makeup of conventional distilled plum liquor

| | Distilled |
|---|---|
| | plum liquor A |
| | (unrefined |
| | liquor:water = 1:2) |
| | (ppm) |
| Diethyl malate | 4.4 |
| Diethyl succinate | 1.1 |
| Triethyl citrate | 0.3 |
| Acetic acid | 13.4 |
| Isobutyric acid | 0.1 |
| 2-Methylbutyric acid | 0.3 |
| Caproic acid | 3.3 |
| Ethyl benzoate | 0.3 |
| Benzaldehyde | 13.3 |
| Benzyl alcohol | 1.8 |

### <Evaluation Results>

The results of the sensory evaluation of sample Nos. 1 to 7 are shown in Table 2. It was found that distilled plum liquor A (sample No. 1) prepared by diluting the unrefined distilled plum liquor contains 4.4 ppm of diethyl malate, 1.1 ppm of diethyl succinate, and 0.3 ppm of triethyl citrate, and is uncomfortable to drink since bitterness and astringency linger in the mouth. It was also found that the distilled plum liquors of sample Nos. 2 and 3, which are characterized by having increased concentrations of diethyl malate, are more uncomfortable to drink. Further, it was found that the same tendency was observed in the cases of adding diethyl succinate (sample Nos. 4, 5), and that in the cases of adding triethyl citrate (sample Nos. 6, 7), as its concentration increases, bitterness and astringency lingering in the mouth become more prominent, thereby causing a distilled plum liquor to be more uncomfortable to drink.

Diethyl malate, diethyl succinate, and triethyl citrate are known as pleasant fermentation aroma components contained in plum liquors, wines, and the like. However, it was found that diethyl malate, diethyl succinate, and triethyl citrate cause an unpleasant flavor (bitterness and astringency) in distilled plum liquors.

TABLE 2
Evaluation of bitterness/astringency components

| | Diethyl malate | | | Diethyl succinate | | | Triethyl citrate | | |
|---|---|---|---|---|---|---|---|---|---|
| | Sample | Sample | Sample | Sample | Sample | Sample | Sample | Sample | Sample |
| | No. 1 | No. 2 | No. 3 | No. 1 | No. 4 | No. 5 | No. 1 | No. 6 | No. 7 |
| Relative | 0 | 10.0 | 20.0 | 0 | 10.0 | 20.0 | 0 | 10.0 | 20.0 |
| additional | | | | | | | | | |
| amount of | | | | | | | | | |
| bitterness/ | | | | | | | | | |
| astringency | | | | | | | | | |
| component | | | | | | | | | |
| (ppm) | | | | | | | | | |
| Relative | 4.4 | 14.4 | 24.4 | 1.1 | 11.1 | 21.1 | 0.3 | 10.3 | 20.3 |
| amount of | | | | | | | | | |
| bitterness/ | | | | | | | | | |
| astringency | | | | | | | | | |
| component | | | | | | | | | |
| (ppm) | | | | | | | | | |
| Sensory rating | 4 | 3 | 3 | 4 | 3 | 3 | 4 | 2 | 1 |

### <Analysis of Bitterness/Astringency Masking Effect of Adding Components>

Different distilled plum liquors were prepared with adjustments being made to the concentration of each of seven components (a) to (g), and were evaluated for change in flavor.

The unrefined distilled plum liquor (1 L) was diluted with water (2 L) to prepare distilled plum liquor B (base ingredient) (3 L) having an alcohol content of 9% and containing the certain components at the specified concentrations as shown in Table 3-1. Distilled plum liquor B contained diethyl malate, diethyl succinate, and triethyl citrate at concentrations of 16 ppm, 0.6 ppm, and 1.6 ppm, respectively. Then, aqueous 59% alcohol solutions containing any of components (a) to (g) at concentrations of 10,000 to 50,000 ppm were each added to distilled plum liquor B (30 mL) to prepare different samples each containing any of the components at the specified concentrations as shown in Tables 3-1 and 3-2. The additional relative amounts of the respective components are as shown in Table 4. The different samples were subjected to sensory evaluation by expert panelists who drank 30 mL each of the samples maintained at ordinary temperature. The evaluation was conducted by a point rating system according to the following criteria.

7 points: Extremely comfortable to drink

6 points: Fairly comfortable to drink

5 points: Somewhat comfortable to drink

4 points: Unchanged

3 points: Somewhat uncomfortable to drink

2 points: Fairly uncomfortable to drink

1 point: Extremely uncomfortable to drink

### <Evaluation Results>

The results of the sensory evaluation of the different samples are shown in Tables 3-1, 3-2 and 4. The results in Tables 3-1 and 3-2 revealed that the bitterness and astringency derived from diethyl malate, diethyl succinate, and triethyl citrate can be reduced by incorporating any of components (a) to (g) at specified concentrations. It was found that the masking effect becomes prominent particularly in the case of adding any of components (a) to (c).

TABLE 3-1
Relationship between relative component amount and bitterness/astringency masking effect

| | Base | | | | | | | | | | | | | |
|---|---|---|---|---|---|---|---|---|---|---|---|---|---|---|
| | ingredient | Base ingredient + component | | | | | | | | | | | | |
| Relative amount of | 0.5 | 0.7 | 0.9 | 1.5 | 3.0 | 5.5 | 10.5 | 20.5 | 30.5 | 40.5 | 50.5 | 60.5 | 70.5 | 80.5 |
| (a) isobutyric acid | | | | | | | | | | | | | | |
| (a)/(h) | 0.03 | 0.04 | 0.06 | 0.09 | 0.19 | 0.34 | 0.66 | 1.28 | 1.91 | 2.53 | 3.16 | 3.78 | 4.41 | 5.03 |
| (a)/(i) | 0.8 | 1.2 | 1.5 | 2.5 | 5.0 | 9.2 | 17.5 | 34.2 | 50.8 | 67.5 | 84.2 | 100.8 | 117.5 | 134.2 |
| (a)/(j) | 0.3 | 0.4 | 0.6 | 0.9 | 1.9 | 3.4 | 6.6 | 12.8 | 19.1 | 25.3 | 31.6 | 37.8 | 44.1 | 50.3 |
| Sensory rating | 4 | 5 | 6 | 7 | 7 | 7 | 7 | 7 | 6 | 6 | 5 | 5 | 5 | 4 |
| Relative amount of | 12.3 | 12.5 | 12.7 | 13.3 | 14.8 | 17.3 | 22.3 | 32.3 | 42.3 | 52.3 | 62.3 | 72.3 | 82.3 | 92.3 |
| (b) acetic acid | | | | | | | | | | | | | | |
| (b)/(h) | 0.77 | 0.78 | 0.79 | 0.83 | 0.93 | 1.08 | 1.39 | 2.02 | 2.64 | 3.27 | 3.89 | 4.52 | 5.14 | 5.77 |
| (b)/(i) | 20.5 | 20.8 | 21.2 | 22.2 | 24.7 | 28.8 | 37.2 | 53.8 | 70.5 | 87.2 | 103.8 | 120.5 | 137.2 | 153.8 |
| (b)/(j) | 7.7 | 7.8 | 7.9 | 8.3 | 9.3 | 10.8 | 13.9 | 20.2 | 26.4 | 32.7 | 38.9 | 45.2 | 51.4 | 57.7 |
| Sensory rating | 4 | 4 | 5 | 5 | 6 | 7 | 7 | 7 | 7 | 6 | 6 | 5 | 5 | 4 |
| Relative amount of | 12.1 | 12.3 | 12.5 | 13.1 | 14.6 | 17.1 | 22.1 | 32.1 | 42.1 | 52.1 | 62.1 | 72.1 | 82.1 | 92.1 |
| (c) benzaldehyde | | | | | | | | | | | | | | |
| (c)/(h) | 0.76 | 0.77 | 0.78 | 0.82 | 0.91 | 1.07 | 1.38 | 2.01 | 2.63 | 3.26 | 3.88 | 4.51 | 5.13 | 5.76 |
| (c)/(i) | 20.2 | 20.5 | 20.8 | 21.8 | 24.3 | 28.5 | 36.8 | 53.5 | 70.2 | 86.8 | 103.5 | 120.2 | 136.8 | 153.5 |
| (c)/(j) | 7.6 | 7.7 | 7.8 | 8.2 | 9.1 | 10.7 | 13.8 | 20.1 | 26.3 | 32.6 | 38.8 | 45.1 | 51.3 | 57.6 |
| Sensory rating | 4 | 4 | 5 | 5 | 5 | 6 | 7 | 7 | 7 | 7 | 6 | 5 | 4 | 4 |

(For each of (a) to (c), the top row represents the change in relative component amount (ppm); the middle rows represent the change in the component ratio relative to each of (h) to (j); and the bottom row represents the change in sensory rating.)

TABLE 3-2
Relationship between relative component amount and bitterness/astringency masking effect (continued)

| | Base | | | | | | | | | | | | | |
|---|---|---|---|---|---|---|---|---|---|---|---|---|---|---|
| | ingredient | Base ingredient + component | | | | | | | | | | | | |
| Relative amount of | 0.5 | 0.7 | 0.9 | 1.5 | 3.0 | 5.5 | 10.5 | 20.5 | 30.5 | 40.5 | 50.5 | 60.5 | 70.5 | 80.5 |
| (d) 2-methylbutyric | | | | | | | | | | | | | | |
| acid | | | | | | | | | | | | | | |
| (d)/(h) | 0.03 | 0.04 | 0.06 | 0.09 | 0.19 | 0.34 | 0.66 | 1.28 | 1.91 | 2.53 | 3.16 | 3.78 | 4.41 | 5.03 |
| (d)/(i) | 0.8 | 1.2 | 1.5 | 2.5 | 5.0 | 9.2 | 17.5 | 34.2 | 50.8 | 67.5 | 84.2 | 100.8 | 117.5 | 134.2 |
| (d)/(j) | 0.3 | 0.4 | 0.6 | 0.9 | 1.9 | 3.4 | 6.6 | 12.8 | 19.1 | 25.3 | 31.6 | 37.8 | 44.1 | 50.3 |
| Sensory rating | 4 | 4 | 5 | 5 | 5 | 5 | 5 | 4 | 4 | 4 | 4 | 4 | 4 | 3 |
| Relative amount of | 4.6 | 4.8 | 5 | 5.6 | 7.1 | 9.6 | 14.6 | 24.6 | 34.6 | 44.6 | 54.6 | 64.6 | 74.6 | 84.6 |
| (e) caproic acid | | | | | | | | | | | | | | |
| (e)/(h) | 0.29 | 0.30 | 0.31 | 0.35 | 0.44 | 0.60 | 0.91 | 1.54 | 2.16 | 2.79 | 3.41 | 4.04 | 4.66 | 5.29 |
| (e)/(i) | 7.7 | 8.0 | 8.3 | 9.3 | 11.8 | 16.0 | 24.3 | 41.0 | 57.7 | 74.3 | 91.0 | 107.7 | 124.3 | 141.0 |
| (e)/(j) | 2.9 | 3.0 | 3.1 | 3.5 | 4.4 | 6.0 | 9.1 | 15.4 | 21.6 | 27.9 | 34.1 | 40.4 | 46.6 | 52.9 |
| Sensory rating | 4 | 4 | 5 | 5 | 6 | 6 | 6 | 5 | 5 | 5 | 4 | 4 | 4 | 3 |
| Relative amount of | 1.0 | 1.2 | 1.4 | 2.0 | 3.5 | 6.0 | 11.0 | 21.0 | 31.0 | 41.0 | 51.0 | 61.0 | 71.0 | 81.0 |
| (f) ethyl benzoate | | | | | | | | | | | | | | |
| (f)/(h) | 0.06 | 0.08 | 0.09 | 0.13 | 0.22 | 0.38 | 0.69 | 1.31 | 1.94 | 2.56 | 3.19 | 3.81 | 4.41 | 5.06 |
| (f)/(i) | 1.7 | 2.0 | 2.3 | 3.3 | 5.8 | 10.0 | 18.3 | 35.0 | 51.7 | 68.3 | 85.0 | 101.7 | 118.3 | 135.0 |
| (f)/(j) | 0.6 | 0.8 | 0.9 | 1.3 | 2.2 | 3.8 | 6.9 | 13.1 | 19.4 | 25.6 | 31.9 | 38.1 | 44.4 | 50.6 |
| Sensory rating | 4 | 5 | 5 | 5 | 5 | 4 | 4 | 4 | 4 | 4 | 3 | 3 | 3 | 3 |
| Relative amount of | 1.7 | 1.9 | 2.1 | 2.7 | 4.2 | 6.7 | 11.7 | 21.7 | 31.7 | 41.7 | 51.7 | 61.7 | 71.7 | 81.7 |
| (g) benzyl alcohol | | | | | | | | | | | | | | |
| (g)/(h) | 0.11 | 0.12 | 0.13 | 0.17 | 0.26 | 0.42 | 0.73 | 1.36 | 1.98 | 2.61 | 3.23 | 3.86 | 4.48 | 5.11 |
| (g)/(i) | 2.8 | 3.2 | 3.5 | 4.5 | 7.0 | 11.2 | 19.5 | 36.2 | 52.8 | 69.5 | 86.2 | 102.8 | 119.5 | 136.2 |
| (g)/(j) | 1.1 | 1.2 | 1.3 | 1.7 | 2.6 | 4.2 | 7.3 | 13.6 | 19.8 | 26.1 | 32.3 | 38.6 | 14.8 | 51.1 |
| Sensory rating | 4 | 5 | 5 | 5 | 5 | 5 | 4 | 4 | 4 | 4 | 4 | 3 | 3 | 3 |

(For each of (d) to (g), the top row represents the change in relative component amount (ppm); the middle rows represent the change in the component ratio relative to each of (h) to (j); and the bottom row represents the change in sensory rating.)

TABLE 4
Relationship between an increase in component concentration and bitterness/astringency masking effect

| Base | | | | | | | | | | | | | |
|---|---|---|---|---|---|---|---|---|---|---|---|---|---|
| ingredient | Relative additional amount of component (ppm) | | | | | | | | | | | | |
| 0 | 0.2 | 0.4 | 1 | 2.5 | 5 | 10 | 20 | 30 | 40 | 50 | 60 | 70 | 80 |

Ratio of relative additional amount of components to relative amount of each of bitterness/astringency components
(i.e., relative additional amount of (a) to (g) vs. weight of each of (h) to (j))

| | | | | | | | | | | | | | | |
|---|---|---|---|---|---|---|---|---|---|---|---|---|---|---|
| (a) to (g)/(h) | — | 0.01 | 0.03 | 0.06 | 0.16 | 0.31 | 0.63 | 1.25 | 1.88 | 2.50 | 3.13 | 3.75 | 4.38 | 5.00 |
| (a) to (g)/(i) | — | 0.3 | 0.7 | 1.7 | 4.2 | 8.3 | 16.7 | 33.3 | 50.0 | 66.7 | 83.3 | 100.0 | 116.7 | 133.3 |
| (a) to (g)/(j) | — | 0.1 | 0.3 | 0.6 | 1.6 | 3.1 | 6.3 | 12.5 | 18.8 | 25.0 | 31.3 | 37.5 | 43.8 | 50.0 |

Sensory rating

| | | | | | | | | | | | | | | |
|---|---|---|---|---|---|---|---|---|---|---|---|---|---|---|
| (a) isobutyric acid | 4 | 5 | 6 | 7 | 7 | 7 | 7 | 7 | 6 | 6 | 5 | 5 | 5 | 4 |
| (b) Acetic acid | 4 | 4 | 5 | 5 | 6 | 7 | 7 | 7 | 7 | 6 | 6 | 5 | 5 | 4 |
| (c) Benzaldehyde | 4 | 4 | 5 | 5 | 5 | 6 | 7 | 7 | 7 | 7 | 6 | 5 | 4 | 4 |
| (d) 2-Methylbutyric | 4 | 4 | 5 | 5 | 5 | 5 | 5 | 4 | 4 | 4 | 4 | 4 | 4 | 3 |
| acid | | | | | | | | | | | | | | |
| (e) Caproic acid | 4 | 4 | 5 | 5 | 6 | 6 | 6 | 5 | 5 | 5 | 4 | 4 | 4 | 3 |
| (f) Ethyl benzoate | 4 | 5 | 5 | 5 | 5 | 4 | 4 | 4 | 4 | 4 | 3 | 3 | 3 | 3 |
| (g) Benzyl alcohol | 4 | 5 | 5 | 5 | 5 | 5 | 4 | 4 | 4 | 4 | 4 | 3 | 3 | 3 |

### Example 2: Evaluation of the Effects Obtained by Adding Different Combinations of at Least Two Components

There were three different components (isobutyric acid, acetic acid, and benzaldehyde) which were rated the highest score (7 points) in the bitterness/astringency masking evaluation test conducted in Example 1. These components were evaluated as to the effects of their different combinations. The sensory evaluation was conducted according to the same procedure as in Example 1, except that the following criteria were used, with the highest score (7 points) given when adding any one of these components alone in Example 1 serving as a reference point.

8 points: More pleasant as compared to 7 points given in Example 1

9 points: Extremely pleasant as compared to 7 points given in Example 1

### <Evaluation Results>

The results in Table 5 revealed that when at least two of three components (a) to (c) are added in combination at specified concentrations, the bitterness and astringency derived from the unrefined distilled plum liquor can be reduced more effectively. In other words, it was found that the effects of adding at least two of these components in combination are superior to those of adding any one of them alone. In particular, an extremely superior effect was obtained by adding benzaldehyde in combination with either or both of the other components.

TABLE 5
Evaluation of the effects of adding different
combinations of two components

| | Sensory |
|---|---|
| Combination of components * | rating |
| Acetic acid (10 ppm) + Isobutyric acid (3 ppm) | 8 |
| Acetic acid (10 ppm) + Benzaldehyde (20 ppm) | 9 |
| Isobutyric acid (3 ppm) + Benzaldehyde (20 ppm) | 9 |

* The value enclosed in paretheses represents the relative additional amount of a component.

### Example 3: Evaluation of the Effect Obtained by Adding a Combination of Several Components

Seven components (a) to (g) were added to 30 mL of the distilled plum liquor (i.e., distilled plum liquor B produced in Example 1) to prepare distilled plum liquor C. Distilled plum liquor B, the flavorant additive, and distilled plum liquor C contained the certain components in the specified relative amounts as shown in Table 6. The sensory evaluation was conducted according to the same procedure as in Example 1.

The results shown in Table 6 confirmed that distilled plum liquor C, which was prepared by adjusting the concentrations of seven components (a) to (g) to be in the ranges determined to be preferable based on the results in Example 1, showed reduction in bitterness and astringency and enhancement in pleasant taste, as compared to distilled plum liquor B containing the same amounts of diethyl malate, diethyl succinate, and triethyl citrate which cause the generation of unpleasant bitterness and astringency.

TABLE 6
Evaluation of the effect of adding
a combination of several components

| | Distilled | Additive | |
|---|---|---|---|
| | plum liquor B | (relative | |
| | (unrefined | additional | Distilled |
| | liquor:water = 1:2) | amount) | plum liquor C |
| | (ppm) | (ppm) | (ppm) |
| Diethyl malate | 16.0 | — | 16.0 |
| Diethyl succinate | 0.6 | — | 0.6 |
| Triethyl citrate | 1.6 | — | 1.6 |
| Acetic acid | 12.3 | 9.0 | 51.3 |
| Isobutyric acid | 0.5 | 3.2 | 3.7 |
| 2-Methylbutyric acid | 0.5 | 2.0 | 2.5 |
| Caproic acid | 4.6 | 4.9 | 9.5 |
| Ethyl benzoate | 1.0 | 0.4 | 1.4 |
| Benzaldehyde | 12.1 | 25.3 | 17.4 |
| Benzyl alcohol | 1.7 | 0.4 | 2.1 |
| Sensory rating | 4 | — | 7 |

### Production Example 1: Distilled Plum Liquor (Containing a Sugar, an Acidulant, and Flavorant Components)

Certain additives were added to an unrefined distilled plum liquor containing specified amounts of components as shown in Table 7 below, whereby a distilled plum liquor was produced. The distilled plum liquor was adjusted to an alcohol content of 10% by adding water.

TABLE 7
<Distilled plum liquors>

| Component | Sample A | | Sample B | |
|---|---|---|---|---|
| Unrefined distilled plum liquor | 300 | mL | 300 | mL |
| High-fructose corn syrup | — | | 100 | g |
| Citric acid | — | | 4.7 | g |
| Spirits (alcohol content: 59%) | 50 | mL | 50 | mL |
| Acetic acid | 9.0 | mg | 9.0 | mg |
| Isobutyric acid | 3.2 | mg | 3.2 | mg |
| 2-Methylbutyric acid | 2.0 | mg | 2.0 | mg |
| Caproic acid | 4.9 | mg | 4.9 | mg |
| Ethyl benzoate | 0.4 | mg | 0.4 | mg |
| Benzaldehyde | 25.3 | mg | 25.3 | mg |
| Benzyl alcohol | 0.4 | mg | 0.4 | mg |
| Water *The volume was adjusted to give a total | balance | | balance | |
| volume of 1000 mL. | | | | |
| Total volume | 1,000 | mL | 1,000 | mL |

The results in Table 7 revealed that sample B is improved in comfort in drinking as compared to sample A. Thus, it was found that a distilled plum liquor can be further improved in comfort in drinking by adding subsidiary ingredients such as a sugar and an acidulant.

### INDUSTRIAL APPLICABILITY

When a specified amount of at least one selected from isobutyric acid, acetic acid and benzaldehyde is incorporated in an unrefined distilled plum liquor, the peculiar discomfort in drinking which is derived from bitterness/astringency components can be eliminated, thereby obtaining a distilled plum liquor with an extremely pleasant taste.

1. A distilled plum liquor, comprising at least one selected from the following components, based on the total amount of the distilled plum liquor:
(a) 0.6 to 75 ppm of isobutyric acid,
(b) 12.6 to 85 ppm of acetic acid, and
(c) 12.4 to 77 ppm of benzaldehyde.

2. The distilled plum liquor according to claim 1, comprising at least two selected from the components (a) to (c).

3. The distilled plum liquor according to claim 1, further comprising at least one selected from the following components, based on the total amount of the distilled plum liquor:
(d) 0.8 to 15 ppm of 2-methylbutyric acid,
(e) 4.9 to 50 ppm of caproic acid,
(f) 1.1 to 4.5 ppm of ethyl benzoate, and
(g) 1.8 to 9 ppm of benzyl alcohol.

4. The distilled plum liquor according to claim 1, further comprising at least one selected from the following components, based on the total amount of the distilled plum liquor:
(h) 1 to 50 ppm of diethyl malate,
(i) 0.1 to 2 ppm of diethyl succinate, and
(j) 0.1 to 5 ppm of triethyl citrate.

5. A distilled plum liquor, comprising:
at least one selected from (a) isobutyric acid, (b) acetic acid, and (c) benzaldehyde; and
at least one selected from (h) diethyl malate, (i) diethyl succinate, and (j) triethyl citrate;
wherein the relative ratios of the components satisfy the following relations:
[weight of (a)/weight of (h)]=0.04 to 4.8,
[weight of (b)/weight of (h)]=0.79 to 5.4,
[weight of (c)/weight of (h)]=0.78 to 4.82,
[weight of (a)/weight of (i)]=1.0 to 125,
[weight of (b)/weight of (i)]=21 to 142,
[weight of (c)/weight of (i)]=20.6 to 129,
[weight of (a)/weight of (j)]=0.35 to 47,
[weight of (b)/weight of (j)]=7.75 to 55, and
[weight of (c)/weight of (j)]=7.75 to 48.

6. The distilled plum liquor according to claim 5, comprising at least two selected from the components (a) to (c).

7. The distilled plum liquor according to claim 5, further comprising at least one selected from (d) 2-methylbutyric acid, (e) caproic acid, (f) ethyl benzoate, and (g) benzyl alcohol,
wherein the relative ratios of the components satisfy the following relations:
[weight of (d)/weight of (h)]=0.05 to 0.94,
[weight of (e)/weight of (h)]=0.31 to 3.13,
[weight of (f)/weight of (h)]=0.07 to 0.28,
[weight of (g)/weight of (h)]=0.12 to 0.56,
[weight of (d)/weight of (i)]=1.3 to 25,
[weight of (e)/weight of (i)]=8.1 to 84,
[weight of (f)/weight of (i)]=1.8 to 7.5,
[weight of (g)/weight of (i)]=1.8 to 15,
[weight of (d)/weight of (j)]=0.5 to 10,
[weight of (e)/weight of (j)]=3.05 to 31,
[weight of (f)/weight of (j)]=0.7 to 3, and
[weight of (g)/weight of (j)]=1.15 to 6.

8. The distilled plum liquor according to claim 5, comprising at least one selected from the following components, based on the total amount of the distilled plum liquor:
(a) 0.6 to 75 ppm of isobutyric acid,
(b) 12.6 to 85 ppm of acetic acid, and
(c) 12.4 to 77 ppm of benzaldehyde.

9. A method for producing a distilled plum liquor, the method comprising the step of adding, to an unrefined distilled plum liquor, at least one selected from the following components in the following relative additional amount(s):
(a) a relative additional amount of 0.1 to 75 ppm of isobutyric acid,
(b) a relative additional amount of 0.3 to 73 ppm of acetic acid, and
(c) a relative additional amount of 0.3 to 65 ppm of benzaldehyde.

10. The method according to claim 9, wherein at the addition step, at least two selected from the components (a) to (c) are added.

11. The method according to claim 9, wherein at the addition step, at least one selected from the following components is further added in the following relative additional amount(s), based on the total amount of the distilled plum liquor:
(d) a relative additional amount of 0.3 to 15 ppm of 2-methylbutyric acid,
(e) a relative additional amount of 0.3 to 46 ppm of caproic acid,
(f) a relative additional amount of 0.1 to 3.5 ppm of ethyl benzoate, and
(g) a relative additional amount of 0.1 to 7.5 ppm of benzyl alcohol.

12. The method according to any one of claim 9, wherein at the addition step, at least one selected from the following components is further incorporated, based on the total amount of the distilled plum liquor:
(h) 1 to 50 ppm of diethyl malate,
(i) 0.1 to 2 ppm of diethyl succinate, and
(j) 0.1 to 5 ppm of triethyl citrate.
